(19) United States
(12) Patent Application Publication
(10) Pub. No.: US 2015/0125543 A1
(43) Pub. Date: May 7, 2015

(54) GEL DISINFECTING COMPOSITION

(71) Applicant: Simple Science Limited, Waterford (IE)

(72) Inventors: Eoin Croke, Kilkenny (IE); Danielle Power, Waterford (IE)

(73) Assignee: Simple Science Limited, Waterford (IE)

(21) Appl. No.: 14/074,527

(22) Filed: Nov. 7, 2013

(51) Int. Cl. A01N 59/26; A01N 59/00; A01N 59/10

(52) U.S. Cl. CPC A01N 59/26; A01N 59/10; A01N 59/00
USPC 424/606

(57) ABSTRACT

A gel composition that includes: (i) sodium dihydrogen phosphate; (ii) LAPONITE® (sodium magnesium fluorosilicate); (iii) hypochlorous acid; and (iv) water. Also included are methods of manufacturing the gel composition, as well as methods of using the gel composition, e.g., contacting a topical surface of an animal (e.g., human) with the gel composition.

### BACKGROUND

Human and animal health can be adversely affected by many microorganisms, including bacteria, yeasts, viruses, fungi, mold, and protozoa. Human and animal contact with microorganisms is known to cause a wide variety of diseases, illnesses, and ailments.

It is well known that the washing of hard surfaces (e.g. food preparation surfaces and surgical room equipment), food (e.g. fruits and vegetables), and skin (e.g. hands) with soap and water, can remove many microorganisms from those surfaces. Removal of microorganisms by hand washing with soap is largely due to a combination of the surfactancy of the soap and the mechanical action of the washing procedure. Because washing with soap is effective at removing a substantial number of microorganisms already present, but has only a minimal, if any, lasting or persistent effect on microorganisms that subsequently come into contact with the already washed hands, it is often recommended that people wash their hands frequently in order to reduce the spread of viruses, bacteria, and other microorganisms. Compliance with this recommendation is important for an individual's personal health and hygiene, but is especially important for individuals working in the health and food industries.

Antimicrobial cleansing products for the removal of microorganisms from surfaces, including skin, are available in a variety of types. The most common types utilized for personal hygiene and by personnel working in the health and food industries, include those containing soaps and those containing alcohol.

Traditional rinse-off disinfectant products, such as detergents and soaps, are generally effective at reducing the number of microorganisms present on a surface when proper procedures are employed. For example, Dial® liquid soaps containing triclosan, when used for hand washing, have been shown to reduce the number of bacteria present on the skin by about 2.0-2.5 orders of magnitude (99.0-99.7%) after one 30-second hand-wash, as measured by standard Health Care Personal Handwash Tests (HCPHWT). In other words, after washing, the washed skin is contaminated with only 0.3%-1.0% of the number of bacteria than was the unwashed skin before the 30-second hand-wash. Although, when used properly, soaps are capable of removing the majority of bacteria that are present, the persistence of any antimicrobial activity remaining on the surface is minimal, so immediately following hand washing, re-contamination of the hands begins to occur through contact with other contaminated surfaces. In addition, because these traditional rinse-off disinfectant products were developed for use in a washing procedure that uses a substantial amount of water; their use is limited to locations where a substantial amount of water is available.

Another commonly used type of disinfectant are those products containing relatively high levels of alcohol. Alcohol-based disinfectants result in the immediate removal or inactivation of a substantial portion of microorganisms present on the treated surface. Disinfectants based on alcohol, typically ethanol, have an additional advantage as disinfectants because alcohol readily evaporates from the skin at body temperature. Purell® is one example of a skin disinfectant that uses alcohol as the active ingredient. Although properly applied alcohol-based disinfectants are generally effective at removing or destroying bacteria that are present on the skin prior to application, immediately following treatment, re-contamination of treated skin begins to occur through contact with other contaminated surfaces.

Recent studies indicate that alcohol-based sanitizers with less than approximately 60% alcohol content may not be suitable to provide a desirable degree of antimicrobial activity, and alcohol contents above 95% are also less potent because proteins are not denatured easily in the absence of water [“Hand Hygiene Revisited: Another Look at Hand Sanitizers and Antibacterial Soap” SAFEFOOD NEWS—Spring 2004—Vol. 8 No. 3, Colorado State University Cooperative Extension].

Other water-soluble active ingredients have been used in skin disinfectants, instead of, or in combination with, alcohol. Birnbaum et al., (U.S. Pat. No. 6,441,045) disclose a water-soluble quaternary compound for use as a skin disinfectant. Beerse et al., (U.S. Pat. No. 6,217,887) disclose an antimicrobial composition for skin that is meant to be left-on rather than rinsed-off, which contains an antimicrobial active, an anionic surfactant, and a proton-donating agent, in a solution containing up to 98.85% water. Petersen et al., (U.S. Pat. No. 6,627,207) disclose a water-based, quick-drying, gel-type disinfecting composition having a low alcohol content (<30%). Osborne et al., (U.S. Pat. Nos. 5,776,430 and 5,906,808) describe a topical antimicrobial cleanser composition containing 0.65-0.85% chlorhexidine gluconate, or a pharmaceutically acceptable salt, and 50-60% denatured alcohol. Kross (U.S. Pat. No. 5,597,561) discloses water-based, adherent disinfecting composition directed at the prevention of microbial infections, which contains protic acid, a metal chlorite, and a gelling agent. Smyth et al., (U.S. Pat. No. 5,916,568) disclose a quick-drying hand sanitizer composed of alcohol, hydrogen peroxide, and an emollient to help prevent skin irritation. Sawan et al., (U.S. Pat. No. 6,180,584) disclose a disinfectant composition comprised of a polymeric, film-forming material and a metallic biocide in a carrier, which, when applied to a surface, forms a water-insoluble polymeric film on the surface in which the biocide is non-leachably bound to, complexed with, associated with, or dispersed.

Causton et al., (U.S. Pat. No. 5,869,600) disclose the use of water-insoluble, alcohol-soluble copolymers containing some level of quaternary ammonium groups for use as film-forming polymers utilized as antiperspirants.

Other approaches have employed methods that attach reactive silane-based quaternary ammonium compounds to particular substrates via a siloxane bond. For example, AEGIS Environments' product line includes products that utilize polymers of 3-(trimethoxysilyl)propyldimethyloctadecyl ammonium chloride, and are generally applied using alcohol-based solutions. According to product literature, AEM 5700 is 43% 3-(trimethoxysilyl)propyldimethyloctadecyl ammonium chloride in methanol, which can be used to coat the surface of textiles and other objects. This method results in the formation of a permanent covalent bond between the quaternary ammonium antimicrobial compound and the surface being treated. Removal of the applied antimicrobial is thus nearly impossible, even using alcohol-based solvents. Furthermore, the reactive trimethoxysilyl compounds are toxic and not suitable for use on skin.

Sawan (U.S. Pat. No. 6,264,936) describes an antimicrobial material which can be used to form on the surface of a substrate an antimicrobial coating or layer which kills microorganisms on contact. The antimicrobial coating or layer, characterized in the reference as “non-leaching,” is a combination of an organic matrix immobilized on the surface of the substrate to having biocidal metallic materials associated with the matrix. When a microorganism contacts the coating or layer, the biocidal metallic material is transferred to the microorganism in amounts sufficient to kill it. Specifically, the metallic antimicrobial agent used is silver. Although this method purports to provide a “non-leachable” coating, the mere fact that the metallic antimicrobial agent “is transferred” to the microorganism is contrary to the common definition of non-leachable. Furthermore, it is known that although silver and silver salts have very low solubility, the mechanism of antimicrobial activity is dependent on a finite solution concentration of silver ions. Indeed, Sawan later (column 3, line 9) qualifies the above statement to read “substantially low leachables”. In a preferred embodiment of Sawan's patent, the organic material comprises a polyhexamethylene biguanide polymer which is crosslinked with an epoxide, such as N,N-bismethylene diglycidylaniline, to form a crosslinked network or matrix. This crosslinking step is necessary to prevent dissolution of the matrix. The materials described by Sawan generally require a curing step, generally in the range of 80° to 120° C., which is unsuitable for many substrates, particularly human skin. Furthermore, the preferred organic matrix polymer (polyhexamethylene biguanide) is known to be toxic to human cells in high concentrations (see U.S. Pat. No. 6,369,289 B1). The use of silver as an antimicrobial agent also incurs some undesirable effects. One disadvantage to this approach is that certain bacteria have been able to develop resistance to silver. (Silver S., “Bacterial silver resistance: molecular biology and uses and misuses of silver compounds.” FEMS Microbiology Reviews, 2003; 27:341-353). Another disadvantage to this approach is that diffusing silver may be able to enter the wound and may potentially stain the skin. An additional disadvantage of silver is the high cost of the raw material. Similar approaches are described in U.S. Pat. Nos. 6,180,584; 6,126,931; 6,030,632; 5,869,073, 5,849,311; and 5,817,325.

There is a need for improved means and methods for disinfecting surfaces, not only for improved personal hygiene, but also to reduce potential sources of contamination in both health and food industries. With currently used non-persistent disinfectants, personnel in the health industry (e.g. doctors, nurses, and patients) and the food industry (e.g. food handlers, food preparers, cooks, and servers) must apply a disinfectant, such as soap, to their skin several, and sometimes 20 or more times, a day. Consequently, there exists a need, for personal hygiene and hygiene within the health and food industries, for a disinfectant that can effectively sanitize a surface and persist actively on that surface to combat microorganisms that subsequently come into contact with the treated surface.

The need for an effective, persistent surface disinfectant is felt in all aspects of the health industry. It is an aspect of the current invention that the invention would be useful to disinfect skin prior to surgery, injection, phlebotomy, and catheter insertion. Microorganisms present a threat to the health and safety of patients whenever the skin is penetrated, broken, or breached. For example, such pathogens may be a hazard during surgical procedures. Without adequate disinfection of the incision site prior to surgery, microorganisms present on the skin gain access to the incision during or following surgery and cause infection. To prevent such infections, it is critical to disinfect the incision site prior to surgery with a disinfectant that possesses a high antimicrobial activity and a broad spectrum of action. Since surgical procedures can last for many hours, it is also important that the initial disinfection of the incision site persists and provides sustained antimicrobial activity for an extended period of time. In the United States, the Food and Drug Administration requires that a pre-surgical skin disinfectant be capable of reducing the number of flora on dry skin areas, such as an abdomen, by at least 2.5 orders of magnitude or to levels that are too low for reliable quantification (less than about 25 cfu/cm²). On moist skin, such as inguinal areas, the disinfectant must reduce the initial bacterial population by a minimum of 3.2 logs (1.5.times.10³ cfu/mL) and be able to maintain this level for at least four hours.

The need for an effective, persistent, and durable surface disinfectant is also felt in all aspects of the food industry, including food collection (e.g. sanitation of cow teats), food processing (e.g. slaughterhouses), food packaging (e.g. fish canneries), and food distribution (e.g. restaurants and food stores). The composition would be useful wherever a person has food handling responsibilities and particularly useful wherever proper hygiene is made difficult because the same individual has both food handling and money handling responsibilities (e.g. deli shop cashiers and wait staff).

The ability of many organisms to develop resistance to antimicrobial compounds is a serious problem. Reports of rampant infections from organisms such as methacillin-resistant Staph. aureus (MRSA) abound in the news media. Such resistance is known to occur for many antibiotics, as well as for metal-based systems (such as silver). Quaternary ammonium compounds, on the other hand, do not promote development of resistant organisms.

### SUMMARY

The present invention provides a gel composition that includes: (i) sodium dihydrogen phosphate; (ii) LAPONITE® (sodium magnesium fluorosilicate); (iii) hypochlorous acid; and (iv) water.

The present invention also provides a method that includes contacting a topical surface of an animal (e.g., human) with a gel composition that includes: (i) sodium dihydrogen phosphate; (ii) LAPONITE® (sodium magnesium fluorosilicate); (iii) hypochlorous acid; and (iv) water.

In specific embodiments, the gel composition can effectively treat an open wound, on a topical surface of the animal; effectively treat a burn or blister, on a topical surface of the animal; and/or effectively treat an infection, on a topical surface of the animal.

In specific embodiments, the gel composition can effectively treat at least one of a topical bacterial infection, a topical fungal infection, and a topical viral infection.

In specific embodiments, the gel composition can effectively treat at least one of a topical burn, topical blister, open wound, eczema (atopic dermatitis), cold sore (herpes labialis), athlete's foot (ringworm), herpes, wart, and shingles (herpes zoster).

In specific embodiments, the gel composition can effectively kill or inhibit a microorganism or microbe, located on the topical surface of an animal;

In specific embodiments, the gel composition can effectively reduce the number of microorganisms or microbes located on the topical surface of an animal.

### DETAILED DESCRIPTION

Reference will now be made in detail to certain claims of the disclosed invention, examples of which are illustrated in the accompanying structures and formulas. While the disclosed subject matter will be described in conjunction with the enumerated claims, it will be understood that the disclosed subject matter is not intended to limit those claims. On the contrary, the disclosed subject matter is intended to cover all alternatives, modifications, and equivalents, which can be included within the scope of the present invention, as defined by the claims.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention relates to gel disinfecting compositions, methods of preparing the gel disinfecting compositions, methods of using the gel disinfecting compositions, and/or kits that include the gel disinfecting compositions. When describing the present invention, the following terms have the following meanings, unless otherwise indicated.

The term “gel” refers to a solid, jelly-like material that can have properties ranging from soft and weak to hard and tough. Gels are defined as a substantially dilute cross-linked system, which exhibits no flow when in the steady-state. By weight, gels are mostly liquid, yet they behave like solids due to a three-dimensional cross-linked network within the liquid. It is the crosslinking within the fluid that give a gel its structure (hardness) and contribute to the adhesive stick (tack). In this way gels are a dispersion of molecules of a liquid within a solid in which the solid is the continuous phase and the liquid is the discontinuous phase.

Gels typically consist of a solid three-dimensional network that spans the volume of a liquid medium and ensnares it through surface tension effects. This internal network structure may result from physical bonds (physical gels) or chemical bonds (chemical gels), as well as crystallites or other junctions that remain intact within the extending fluid. Virtually any fluid can be used as an extender including water (hydrogels), oil, and air (aerogel). Both by weight and volume, gels are mostly fluid in composition and thus exhibit densities similar to those of their constituent liquids.

The term “sodium dihydrogen phosphate” or “monosodium phosphate” refers to a substance having the molecular formula NaH₂PO₄ and CAS No. 7558-80-7.

The term “sodium magnesium fluorosilicate” refers to a complex compound with low toxicity that is typically used in the cosmetic industry, having the molecular formula F₁₂MgNa₂Si₂ and CAS No. 64060-48-6. The empirical formula is Nap_{0.7}⁺ [(Si₈Mg_{5.5}Li_{0.3})O₂₀(OH)_{2.5}F_{1.5}]_{0.7}—. The compound has the structural formula:

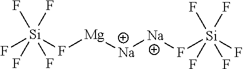

The term “LAPONITE®” refers to a commercially available trademark or brand version (e.g., LAPONITE®laponite XL 21) of the product, sodium magnesium fluorosilicate.

The term “hypochlorous acid” or “chloric(I) acid” or “chloranol” or “hydroxidochlorine” refers to a weak acid with the chemical formula HClO. It forms when chlorine dissolves in water. It cannot be isolated in pure form due to rapid equilibration with its precursor.

The term “substantially devoid” refers to the partial, or complete, absence of a reference substance. For example, the reference substance can be present in less than about 1 wt. %, less than about 0.1 wt. %, or less than about 0.01 wt. %. In specific embodiments, the reference substance can be absent, or can be present in amounts below detection limits employing typical analytical procedures.

The term “C₁-C₁₂ alkanol” refers to an aliphatic (straight-chain, branched, or linear) or cyclic hydrocarbon that includes one or more hydroxyl (—OH) groups. Specific C₁-C₁₂ alkanols include, e.g., methanol, ethanol, and isopropanol.

The term “benzalkonium chloride” or “BZK” or “N-Alkyl-N-benzyl-N,N-dimethylammonium chloride” or “alkyldimethylbenzylammonium chloride” or “ADBAC” or “BC50 BC80” refers to a cationic surface-acting agent belonging to the quaternary ammonium group. The compound has the CAS No. 8424-85-1 and structural formula:

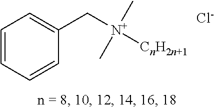

The term “triclosan” refers to the compound 5-chloro-2-(2,4-dichlorophenoxy)phenol, having the CAS No. 3380-34-5 and structural formula:

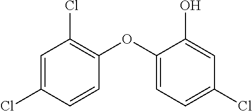 [SMILES: Oc1cc(Cl)ccc1Oc1ccc(Cl)cc1Cl]

The term “fragrance” refers to a chemical compound employed for its smell or odor. A chemical compound has a smell or odor when it is sufficiently volatile to be transported to the olfactory system in the upper part of the nose. Generally molecules meeting this specification have molecular weights of <300 g/mol. Aroma compounds can be found in food, wine, spices, perfumes, fragrance oils, and essential oils.

The term “hypoallergenic” refers to substances (especially cosmetics and textiles) that cause or are claimed to cause fewer (or no) allergic reactions.

The term “antiseptic” refers to antimicrobial substances that are applied to living tissue/skin to reduce the possibility of infection, sepsis, or putrefaction. Antiseptics are generally distinguished from antibiotics by the latter's ability to be transported through the lymphatic system to destroy bacteria within the body, and from disinfectants, which destroy microorganisms found on non-living objects. Some antiseptics are true germicides, capable of destroying microbes (bacteriocidal), while others are bacteriostatic and only prevent or inhibit their growth. Antibacterials are antiseptics that have the proven ability to act against bacteria. Microbicides which destroy virus particles are called viricides or antivirals.

In specific embodiments, the compositions described herein can effectively reduce the possibility of infection, sepsis, and/or putrefaction, when applied to living tissue/skin of an animal. In specific embodiments, the compositions described herein can effectively destroy microorganisms found on non-living objects. In specific embodiments, the compositions described herein can effectively destroy microbes. In specific embodiments, the compositions described herein can effectively prevent or inhibit the growth of microbes. In specific embodiments, the compositions described herein can effectively destroy virus particles.

The term “topical surface” or “topical” refers to outer body surfaces, such as the skin, hair, or mucous membranes.

The term “animal” refers to multicellular, eukaryotic organisms of the kingdom Animalia or Metazoa. Their body plan eventually becomes fixed as they develop, although some undergo a process of metamorphosis later on in their lives. The term is intended to specifically include mammals (e.g., humans) and other vertebrates.

The term “human” refers to are primates of the family Hominidae, and the only extant species of the genus Homo. Humans are distinguished from other primates by their bipedal locomotion, and especially by their relatively larger brain with its particularly well developed neocortex, prefrontal cortex and temporal lobes, which enable high levels of abstract reasoning, language, problem solving, and culture through social learning. Humans use tools to a much higher degree than any other animal, and are the only extant species known to build fires and cook their food, as well as the only known species to clothe themselves and create and use numerous other technologies and arts.

The term “companion animal” or “pet” refers to an animal kept primarily for a person's company or protection, as opposed to working animals, sport animals, livestock, and laboratory animals, which are kept primarily for performance, agricultural value, or research. The most popular pets are noted for their attractive appearances and their loyal or playful personalities. The most popular pets are likely dogs and cats, but people also keep house rabbits; rodents such as gerbils, hamsters, chinchillas, fancy rats, and guinea pigs; avian pets, such as canaries, parakeets, and parrots; reptile pets, such as turtles, lizards and snakes; aquatic pets, such as tropical fish and frogs; and arthropod pets, such as tarantulas and hermit crabs.

The term “livestock” refers to domesticated animals raised in an agricultural setting to produce commodities such as food, fiber and labor.

The term “laboratory animal” refers to non-human animals used in experiments.

The term “zoo animal” refers to animals that are confined in locations having enclosures, are displayed to the public, and may also be bred within such locations.

The term “horse” refers to one of two extant subspecies of Equus ferus, or the wild horse. It is an odd-toed ungulate mammal belonging to the taxonomic family Equidae.

The term “disinfect” or “disinfection” refers to the process of destroying microorganisms that are living on an object. Disinfection does not necessarily kill all microorganisms, especially resistant bacterial spores; it is less effective than sterilization, which is an extreme physical and/or chemical process that kills all types of life. Disinfectants are different from other antimicrobial agents such as antibiotics, which destroy microorganisms within the body, and antiseptics, which destroy microorganisms on living tissue. Disinfectants are also different from biocides—the latter are intended to destroy all forms of life, not just microorganisms. Disinfectants work by destroying the cell wall of microbes or interfering with the metabolism. Sanitizers are substances that simultaneously clean and disinfect.

In specific embodiments, the compositions described herein can effectively destroy microorganisms that are living on an object. In specific embodiments, the compositions described herein can effectively destroy microorganisms on living tissue. In specific embodiments, the compositions described herein can effectively simultaneously clean and disinfect.

The term “wound” refers to a type of injury in which skin is torn, cut, or punctured (an open wound), or where blunt force trauma causes a contusion (a closed wound). In pathology, it specifically refers to a sharp injury which damages the dermis of the skin. Open wounds can be classified according to the object that caused the wound. The types of open wound are:
Incisions or incised wounds, caused by a clean, sharp-edged object such as a knife, razor, or glass splinter.
Lacerations, irregular tear-like wounds caused by some blunt trauma. Lacerations and incisions may appear linear (regular) or stellate (irregular). The term laceration is commonly misused in reference to incisions.
Abrasions (grazes), superficial wounds in which the topmost layer of the skin (the epidermis) is scraped off. Abrasions are often caused by a sliding fall onto a rough surface.
Avulsions, injuries in which a body structure is forcibly detached from its normal point of insertion. A type of amputation where the extremity is pulled off rather than cut off.
Puncture wounds, caused by an object puncturing the skin, such as a splinter, nail or needle.
Penetration wounds, caused by an object such as a knife entering and coming out from the skin.
Gunshot wounds, caused by a bullet or similar projectile driving into or through the body. There may be two wounds, one at the site of entry and one at the site of exit, generally referred to as a “through-and-through.”

The term “burn” refers to a type of injury to flesh or skin caused by heat, electricity, chemicals, friction, or radiation. Burns that affect only the superficial skin are known as superficial or first-degree burns. When damage penetrates into some of the underlying layers, it is a partial-thickness or second-degree burn. In a full-thickness or third-degree burn, the injury extends to all layers of the skin. A fourth-degree burn additionally involves injury to deeper tissues, such as muscle or bone.

The term “blister” refers to a small pocket of fluid within the upper layers of the skin, typically caused by forceful rubbing (friction), burning, freezing, chemical exposure or infection. Most blisters are filled with a clear fluid called serum or plasma. However, blisters can be filled with blood (known as blood blisters) or with pus (if they become infected).

The term “infection” refers to the invasion of a host organism's bodily tissues by disease-causing organisms, their multiplication, and the reaction of host tissues to these organisms and the toxins they produce. Infections are caused by infectious agents such as viruses, viroids, and prions, microorganisms such as bacteria, nematodes such as roundworms and pinworms, arthropods such as ticks, mites, fleas, and lice, fungi such as ringworm, and other macroparasites such as tapeworms.

The term “bacterial infection” refers to the infection of a host by pathogenic bacteria.

The term “eczema” or “atopic dermatitis” refers to a form of chronic inflammation of the skin. The term eczema refers to a set of clinical characteristics. Classification of the underlying diseases has been haphazard and unsystematic, with many synonyms used to describe the same condition. A type of eczema may be described by location (e.g., hand eczema), by specific appearance (eczema craquele or discoid), or by possible cause (varicose eczema). Further adding to the confusion, many sources use the term eczema for the most common type of eczema (atopic dermatitis) interchangeably.

The term “cold sore” or “herpes labialis” refers to a type of herpes simplex occurring on the lip, i.e. an infection caused by herpes simplex virus (HSV). An outbreak typically causes small blisters or sores on or around the mouth commonly known as cold sores or fever blisters. The sores typically heal within 2-3 weeks, but the herpes virus remains dormant in the facial nerves, following orofacial infection, periodically reactivating (in symptomatic people) to create sores in the same area of the mouth or face at the site of the original infection. Cold sore has a rate of frequency that varies from rare episodes to 12 or more recurrences per year. People with the condition typically experience one to three attacks annually. The frequency and severity of outbreaks generally decreases over time.

The term “athlete's foot” or ringworm” refers to a fungal infection of the skin that causes scaling, flaking, and itch of affected areas, and in severe cases, swelling and amputation of the foot. It is caused by fungi in the genus Trichophyton. The disease is typically transmitted in moist communal areas where people walk barefoot, such as showers or bathhouses,[citation needed] and requires a warm moist environment, such as the inside of a shoe, in order to incubate. Although the condition typically affects the feet, it can infect or spread to other areas of the body, including the groin, particularly areas of skin that are kept hot and moist, such as with insulation, body heat, and sweat, e.g. in a shoe, for long periods of time. While the fungus is generally picked up through walking barefoot in an infected area or using an infected towel, infection can be prevented by remaining barefoot as this allows the feet to dry properly and removes the fungus' primary incubator—the warm moist interior of a shoe. Athlete's foot can be treated by a very limited number of pharmaceuticals (including creams) and other treatments, although it can be almost completely prevented by never wearing shoes, or wearing them as little as possible. Globally it affects about 15% of the population.

The term “herpes” or “herpes simplex” refers to a viral disease from the herpesviridae family caused by both Herpes simplex virus type 1 (HSV-1) and type 2 (HSV-2). Infection with the herpes virus is categorized into one of several distinct disorders based on the site of infection. Oral herpes, the visible symptoms of which are colloquially called cold sores or fever blisters, is an infection of the face or mouth. Oral herpes is the most common form of infection. Genital herpes, known simply as herpes, is the second most common form of herpes. Other disorders such as herpetic whitlow, herpes gladiatorum, ocular herpes, cerebral herpes infection encephalitis, Mollaret's meningitis, neonatal herpes, and possibly Bell's palsy are all caused by herpes simplex viruses.

The term “wart” refers to a small, rough growth resembling a cauliflower or a solid blister. It typically occurs on humans' hands or feet but often in other locations. Warts are caused by a viral infection, specifically by one of the many types of human papillomavirus (HPV). There are as many as 10 varieties of warts, the most common considered to be mostly harmless. It is possible to get warts from others; they are contagious and usually enter the body in an area of broken skin. They typically disappear after a few months but can last for years and can reoccur.

The term “shingles” or “herpes zoster” refers to a viral disease characterized by a painful skin rash with blisters in a limited area on one side of the body (left or right), often in a stripe. The initial infection with varicella zoster virus (VZV) causes the acute, short-lived illness chickenpox which generally occurs in children and young adults. Once an episode of chickenpox has resolved, the virus is not eliminated from the body and can go on to cause shingles—an illness with very different symptoms—often many years after the initial infection. Herpes zoster is not the same disease as herpes simplex, despite the name similarity; both the varicella zoster virus and herpes simplex virus belong to the same viral subfamily Alphaherpesvirinae.

As used herein, “fungi” or “fungus” refers to a large and diverse group of eucaryotic microorganisms whose cells contain a nucleus, vacuoles, and mitochondria. Fungi include algae, molds, yeasts, mushrooms, and slime molds. See, Biology of Microorganisms, T. Brock and M. Madigan, 6th Ed., 1991, Prentice Hill (Englewood Cliffs, N.J.). Exemplary fungi include Ascomycetes (e.g., Neurospora, Saccharomyces, Morchella), Basidiomycetes (e.g., Amanita, Agaricus), Zygomycetes (e.g., Mucor, Rhizopus), Oomycetes (e.g., Allomyces), and Deuteromycetes (e.g., Penicillium, Aspergillus).

As used herein, “algae” refers to a large and diverse assemblage of eucaryotic organisms that contain chlorophyll and carry out oxygenic photosynthesis. See, Biology of Microorganisms, T. Brock and M. Madigan, 6th Ed., 1991, Prentice Hill (Englewood Cliffs, N.J.). Exemplary algae include Green Algae (e.g., Chlamydomonas), Euglenids (e.g., Euglena), Golden Brown Algae (e.g., Navicula), Brown Algae (e.g., Laminaria), Dinoflagellates (e.g., Gonyaulax), and Red Algae (e.g., polisiphonia).

As used herein, “mold” refers to a filamentous fungus, generally a circular colony that may be cottony, wooly, etc. or glabrous, but with filaments not organized into large fruiting bodies, such as mushrooms. See, e.g., Stedman's Medical Dictionary, 25th Ed., Williams & Wilkins, 1990 (Baltimore, Md.). One exemplary mold is the Basidiomycetes called wood-rotting fungi. Two types of wood-rotting fungi are the white rot and the brown rot. An ecological activity of many fungi, especially members of the Basidiomycetes is the decomposition of wood, paper, cloth, and other products derived from natural sources. Basidiomycetes that attack these products are able to utilize cellulose or lignin as carbon and energy sources. Lignin is a complex polymer in which the building blocks are phenolic compounds. It is an important constituent of woody plants. The decomposition of lignin in nature occurs almost exclusively through the agency of these wood-rotting fungi. Brown rot attacks and decomposes the cellulose and the lignin is left unchanged. White rot attacks and decomposes both cellulose and lignin. See, Biology of Microorganisms, T. Brock and M. Madigan, 6th Ed., 1991, Prentice Hill (Englewood Cliffs, N.J.).

As used herein, “yeast” refers to unicellular fungi, most of which are classified with the Ascomytes. See, Biology of Microorganisms, T. Brock and M. Madigan, 6th Ed., 1991, Prentice Hill (Englewood Cliffs, N.J.).

As used herein, “mushrooms” refer to filamentous fungi that are typically from large structures called fruiting bodies, the edible part of the mushroom. See, Biology of Microorganisms, T. Brock and M. Madigan, 6th Ed., 1991, Prentice Hill (Englewood Cliffs, N.J.).

As used herein, “slime molds” refers to nonphototrophic eucaryotic microorganisms that have some similarity to both fungi and protozoa. The slime molds can be divided into two groups, the cellular slime molds, whose vegetative forms are composed of single amoeba-like cells, and the acellular slime molds, whose vegetive forms are naked masses of protoplasms of indefinite size and shape called plasmodia. Slime molds live primarily on decaying plant matter, such as wood, paper, and cloth. See, Biology of Microorganisms, T. Brock and M. Madigan, 6th Ed., 1991, Prentice Hill (Englewood Cliffs, N.J.).

As used herein, a “virus” refers to a small infectious agent that can replicate only inside the living cells of organisms. Virus particles (known as virions) consist of two or three parts: the genetic material made from either DNA or RNA, long molecules that carry genetic information; a protein coat that protects these genes; and in some cases an envelope of lipids that surrounds the protein coat when they are outside a cell. The shapes of viruses range from simple helical and icosahedral forms to more complex structures. The average virus is about one one-hundredth the size of the average bacterium. An enormous variety of genomic structures can be seen among viral species; as a group they contain more structural genomic diversity than plants, animals, archaea, or bacteria. There are millions of different types of viruses, although only about 5,000 of them have been described in detail. A virus has either DNA or RNA genes and is called a DNA virus or a RNA virus respectively. The vast majority of viruses have RNA genomes. Plant viruses tend to have single-stranded RNA genomes and bacteriophages tend to have double-stranded DNA genomes.

### Method of Preparing a Gel Disinfecting Composition

The present invention provides for methods of preparing a gel disinfecting composition. The methods can include contacting: (i) sodium dihydrogen phosphate; (ii) LAPONITE® (sodium magnesium fluorosilicate); (iii) hypochlorous acid; and (iv) water, under conditions suitable to effectively provide the gel disinfecting composition.

### Methods of Using the Gel Disinfecting Composition

The gel disinfecting composition can be used in a wide-variety of applications or uses. Typically, the gel disinfecting composition will be used to: reduce the possibility of infection, sepsis, and/or putrefaction, when applied to living tissue/skin of an animal; destroy microorganisms found on non-living objects or on living tissue/skin of an animal; destroy microbes found on non-living objects or on living tissue/skin of an animal; prevent or inhibit the growth of microbes found on non-living objects or on living tissue/skin of an animal; destroy virus particles found on non-living objects or on living tissue/skin of an animal; and/or simultaneously clean and disinfect a non-living object or living tissue/skin of an animal.

Specific enumerated embodiments [1] to [27] provided below are for illustration purposes only, and do not otherwise limit the scope of the disclosed subject matter, as defined by the claims. These enumerated embodiments encompass all combinations, sub-combinations, and multiply referenced (e.g., multiply dependent) combinations described therein.

### Enumerated Embodiments

[1.] The present invention provides for a gel composition that includes:

(i) sodium dihydrogen phosphate;

(ii) LAPONITE® (sodium magnesium fluorosilicate);

(iii) hypochlorous acid; and

(iv) water.
[2.] The composition of the above embodiment, wherein the sodium dihydrogen phosphate is present in about 0.10-2.0 wt. %.
[3.] The composition of any one of the above embodiments, wherein the LAPONITE® (sodium magnesium fluorosilicate) is present in about 0.5-3.0 wt. %.
[4.] The composition of any one of the above embodiments, wherein the hypochlorous acid is present in about 0.0001-0.1 wt. %.
[5.] The composition of any one of the above embodiments, wherein the hypochlorous acid is present in about 95-99 wt. %.
[6.] The composition of any one of the above embodiments, wherein the composition includes:

| | | |
|---|---|---|
| Sodium dihydrogen phosphate | 0.10-2.0 | wt. % |
| LAPONITE ® (sodium magnesium | 0.5-3.0 | wt. %. |
| fluorosilicate) | | |
| Hypochlorous acid | 0.0001-0.1 | wt. %. |

| | |
|---|---|
| Water | q.d. |

[7.] The composition of any one of the above embodiments, wherein the composition includes:

| | |
|---|---|
| Sodium dihydrogen phosphate | 0.16-0.28% |
| LAPONITE ® (sodium magnesium | 2-2.5% |
| fluorosilicate) | |
| Hypochlorous acid | 0.02% |
| Water | q.d. |

[8.] The composition of any one of the above embodiments, wherein the composition includes:

| | |
|---|---|
| Sodium dihydrogen phosphate | 0.6-1.6% |
| LAPONITE ® (sodium magnesium | 1-1.5% |
| fluorosilicate) | |
| Hypochlorous acid | 0.02% |
| Water | q.d. |

[9.] The composition of any one of the above embodiments, substantially devoid of a C₁-C₁₂ alkanol.
[10.] The composition of any one of the above embodiments, substantially devoid of benzalkonium chloride (BZK).
[11.] The composition of any one of the above embodiments, substantially devoid of triclosan.
[12.] The composition of any one of the above embodiments, substantially devoid of fragrance.
[13.] The composition of any one of the above embodiments, which is hypoallergenic.
[14.] The composition of any one of the above embodiments, which is a disinfectant, effective in killing germs.
[15.] The present invention provides for a method that includes contacting a topical surface of an animal with a gel composition of any one of the above embodiments.
[16.] The method of the above embodiment, wherein the animal is a human.
[17.] The method of the above embodiment, wherein the animal is at least one of a companion animal, livestock, laboratory animal, zoo animal, and horse.
[18.] The method of any one of the above embodiments, wherein the gel composition effectively disinfects a topical surface of the animal.
[19.] The method of any one of the above embodiments, wherein the gel composition effectively treats an open wound, on a topical surface of the animal.
[20.] The method of any one of the above embodiments, wherein the gel composition effectively treats a burn or blister, on a topical surface of the animal.
[21.] The method of any one of the above embodiments, wherein the gel composition effectively treats an infection, on a topical surface of the animal.
[22.] The method of any one of the above embodiments, wherein the gel composition effectively treats at least one of a topical bacterial infection, a topical fungal infection, and a topical viral infection.
[23.] The method of any one of the above embodiments, wherein the gel composition effectively treats at least one of a topical burn, topical blister, open wound, eczema (atopic dermatitis), cold sore (herpes labialis), athlete's foot (ringworm), herpes, wart, and shingles (herpes zoster).
[24.] The method of any one of the above embodiments, wherein the gel composition effectively kills or inhibits a microorganism or microbe located on the topical surface of an animal, (e.g., the microbe or microorganism includes at least one of a virus, fungus, mold, slime mold, algae, yeast, mushroom and bacterium).
[25.] The method of any one of the above embodiments, wherein the gel composition effectively reduces the number of microorganisms or microbes located on the topical surface of an animal, (e.g., the microbe or microorganism includes at least one of a virus, fungus, mold, slime mold, algae, yeast, mushroom and bacterium).
[26.] The method of any one of the above embodiments, wherein the gel composition effectively kills or inhibits germs located on the topical surface of an animal.
[27.] The method of any one of the above embodiments, wherein the gel composition effectively reduces the number of germs located on the topical surface of an animal.

Obviously, numerous modifications and variations of the presently disclosed subject matter are possible in light of the above teachings. It is therefore to be understood that within the scope of the appended claims, the disclosed subject matter may be practiced otherwise than as specifically described herein.

Specific ranges, values, and embodiments provided below are for illustration purposes only and do not otherwise limit the scope of the disclosed subject matter, as defined by the claims.

### Specific Ranges, Values, and Embodiments

In a specific embodiment, the sodium dihydrogen phosphate can be present in at least about 0.01 wt. % of the gel composition.

In a specific embodiment, the sodium dihydrogen phosphate can be present in at least about 0.1 wt. % of the gel composition.

In a specific embodiment, the sodium dihydrogen phosphate can be present in at least about 0.15 wt. % of the gel composition.

In a specific embodiment, the sodium dihydrogen phosphate can be present in at least about 0.50 wt. % of the gel composition.

In a specific embodiment, the sodium dihydrogen phosphate can be present in up to about 1.5 wt. % of the gel composition.

In a specific embodiment, the sodium dihydrogen phosphate can be present in up to about 1.0 wt. % of the gel composition.

In a specific embodiment, the sodium dihydrogen phosphate can be present in up to about 0.5 wt. % of the gel composition.

In a specific embodiment, the sodium dihydrogen phosphate can be present in about 0.05 wt. % to about 2.5 wt. % of the gel composition.

In a specific embodiment, the sodium dihydrogen phosphate can be present in about 0.1 wt. % to about 2.0 wt. % of the gel composition.

In a specific embodiment, the sodium dihydrogen phosphate can be present in about 0.6 wt. % to about 1.6 wt. % of the gel composition.

In a specific embodiment, the sodium dihydrogen phosphate can be present in about 0.5 wt. % to about 1.5 wt. % of the gel composition.

In a specific embodiment, the sodium magnesium fluorosilicate can be present in at least about 0.1 wt. % of the gel composition.

In a specific embodiment, the sodium magnesium fluorosilicate can be present in at least about 1.0 wt. % of the gel composition.

In a specific embodiment, the sodium magnesium fluorosilicate can be present in at least about 1.5 wt. % of the gel composition.

In a specific embodiment, the sodium magnesium fluorosilicate can be present in at least about 2.0 wt. % of the gel composition.

In a specific embodiment, the sodium magnesium fluorosilicate can be present in up to about 8.0 wt. % of the gel composition.

In a specific embodiment, the sodium magnesium fluorosilicate can be present in up to about 5.0 wt. % of the gel composition.

In a specific embodiment, the sodium magnesium fluorosilicate can be present in up to about 3.0 wt. % of the gel composition.

In a specific embodiment, the sodium magnesium fluorosilicate can be present in about 0.05 wt. % to about 8.0 wt. % of the gel composition.

In a specific embodiment, the sodium magnesium fluorosilicate can be present in about 0.1 wt. % to about 5.0 wt. % of the gel composition.

In a specific embodiment, the sodium magnesium fluorosilicate can be present in about 0.5 wt. % to about 3.0 wt. % of the gel composition.

In a specific embodiment, the sodium magnesium fluorosilicate can be present in about 2.0 wt. % to about 2.5 wt. % of the gel composition.

In a specific embodiment, the hypochlorous acid can be present in at least about 0.0001 wt. % of the gel composition.

In a specific embodiment, the hypochlorous acid can be present in at least about 0.0002 wt. % of the gel composition.

In a specific embodiment, the hypochlorous acid can be present in at least about 0.005 wt. % of the gel composition.

In a specific embodiment, the hypochlorous acid can be present in at least about 0.01 wt. % of the gel composition.

In a specific embodiment, the hypochlorous acid can be present in at least about 0.02 wt. % of the gel composition.

In a specific embodiment, the hypochlorous acid can be present in at least about 0.05 wt. % of the gel composition.

In a specific embodiment, the hypochlorous acid can be present in up to about 1.0 wt. % of the gel composition.

In a specific embodiment, the hypochlorous acid can be present in up to about 0.5 wt. % of the gel composition.

In a specific embodiment, the hypochlorous acid can be present in up to about 0.1 wt. % of the gel composition.

In a specific embodiment, the hypochlorous acid can be present in up to about 0.05 wt. % of the gel composition.

In a specific embodiment, the hypochlorous acid can be present in about 0.0001 wt. % to about 1.0 wt. % of the gel composition.

In a specific embodiment, the hypochlorous acid can be present in about 0.0002 wt. % to about 1.0 wt. % of the gel composition.

In a specific embodiment, the hypochlorous acid can be present in about 0.0005 wt. % to about 1.0 wt. % of the gel composition.

In a specific embodiment, the hypochlorous acid can be present in about 0.0001 wt. % to about 0.5 wt. % of the gel composition.

In a specific embodiment, the hypochlorous acid can be present in about 0.0001 wt. % to about 0.1 wt. % of the gel composition.

In a specific embodiment, the hypochlorous acid can be present in about 0.0001 wt. % to about 0.01 wt. % of the gel composition.

In a specific embodiment, the hypochlorous acid can be present in about 0.0001 wt. % to about 0.02 wt. % of the gel composition.

### EXAMPLES

### Example 1

### Preparation of Gel Formulation

### Stage 1: 1/5 Ratio Mix

1. Accurately add weighed Laponite XL 21 to accurately measured RO/DI water.
2. Mix at ambient temperature using a high shear mixer for a period of two hours until the mixture is uniform.

### Stage 2: 4/5 Ratio Mix

1. PPM of the anolyte determined using the test method provided.
2. This value is then inputted into a calculation to determine the remaining volume of water that is required to be added to the formulation.
3. This mix is then mixed for a further two hours.

### Stage 3: pH Adjustment

1. Add 0.15% Sodium dihydrogen phosphate buffer to the overall mix.
2. Allow to mix for a further 90 minutes, to ensure a uniform pH throughout the formulation.
3. Final PPM and pH recorded
4. Viscosity determined

### Dilute Anolyte Method:

1. PPM of the raw anolyte determined and inputted into the calculation provided, in order to provide the volume of anolyte required.
2. Add accurately measured RO water and anolyte to a thoroughly cleaned poly mixing tank.
3. Mix the dilute anolyte for a period of five minutes.
4. Confirm PPM and pH of the final dilute anolyte product.
5. Final PPM and pH recorded.

1-14. (canceled)

15. A method of disinfecting a topical surface of an animal, comprising contacting the topical surface with a gel composition comprising:
(i) sodium dihydrogen phosphate;
(ii) sodium magnesium fluorosilicate;
(iii) hypochlorous acid; and
(iv) water.

16. The method of claim 15, wherein the animal is a human.

17. The method of claim 15, wherein the animal is at least one of a companion animal, livestock, laboratory animal, zoo animal, and horse.

18. The method of claim 15, wherein the gel composition disinfects a topical surface of the animal

19. The method of claim 15, wherein the gel composition treats an open wound, on a topical surface of the animal.

20. The method of claim 15, wherein the gel composition treats a burn or blister, on a topical surface of the animal.

21. The method of claim 15, wherein the gel composition treats an infection, on a topical surface of the animal.

22. The method of claim 15, wherein the gel composition treats at least one of a topical bacterial infection, a topical fungal infection, and a topical viral infection.

23. The method of claim 15, wherein the gel composition treats at least one of a topical burn, topical blister, open wound, eczema (atopic dermatitis), cold sore (herpes labialis), athlete's foot (ringworm), herpes, wart, and shingles (herpes zoster).

24. The method of claim 15, wherein the gel composition kills or inhibits a microorganism or microbe located on the topical surface of an animal.

25. The method of claim 15, wherein the gel composition reduces the number of microorganisms or microbes located on the topical surface of an animal.

26. The method of claim 15, wherein the sodium dihydrogen phosphate is present in about 0.10-2.0 wt. %.

27. The method of claim 15, wherein the sodium magnesium fluorosilicate is present in about 0.5-3.0 wt. %.

28. The method of claim 15, wherein the hypochlorous acid is present in about 0.0001-0.1 wt. %.

29. The method of claim 15, wherein the hypochlorous acid is present in about 95-99 wt. %.

30. The method of claim 15, wherein the composition comprises: 0.10-2.0 wt % sodium dihydrogen phosphate, 0.5-3.0 wt % sodium magnesium fluorosilicate, and 0.0001-0.1 wt % hypochlorous acid, in water.

31. The method of claim 15, wherein the composition comprises: 0.16-0.28% sodium dihydrogen phosphate, 2-2.5% sodium magnesium fluorosilicate, and 0.02% hypochlorous acid, in water.

32. The method of claim 15, wherein the composition comprises: 0.6-1.6% sodium dihydrogen phosphate, 1-1.5% sodium magnesium fluorosilicate, and 0.02% hypochlorous acid, in water.

33. The method of claim 15, wherein the composition is devoid of a C₁-C₁₂ alkanol.

34. The method of claim 15, wherein the composition is devoid of benzalkonium chloride (BZK).

35. The method of claim 15, wherein the composition is devoid of triclosan.

36. The method of claim 15, wherein the composition is devoid of fragrance.

37. (canceled)

38. The method of claim 15, wherein the composition is a disinfectant.
